(19) United States
(12) Patent Application Publication
(10) Pub. No.: US 2006/0257525 A1
(43) Pub. Date: Nov. 16, 2006

(54) Product and method for caffeinated alcoholic beverages

(75) Inventor: Michael C. Hearn, San Francisco, CA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Michael C. Hearn, San Francisco, CA (US)

(21) Appl. No.: 11/407,666

(22) Filed: Apr. 20, 2006

Related U.S. Application Data
(60) Provisional application No. 60/673,318, filed on Apr. 20, 2005.

(51) Int. Cl. C12C 11/00

(52) U.S. Cl. 426/11

(57) ABSTRACT

This invention relates to the combination of a clear or translucent alcoholic beverage, such as vodka, gin, rum, tequila, or whisky, with caffeine and flavorant additives, such as sweeteners, masking agents, natural and/or artificial flavoring agents, and/or other additives to eliminate or mitigate the bitter flavoring associated with caffeine. With the caffeinated vodka, gin, rum, tequila, or whisky of the invention, individuals will be able to achieve the stimulation of caffeine combined with the euphoria of a spirit in one beverage and be able to drink the beverage by itself or combined with a favorite mixer of choice.

### RELATED APPLICATIONS

This non-provisional application claims the benefit under Title 35, U.S.C. § 119(e) of co-pending U.S. provisional application Ser. No. 60/673,318, filed Apr. 20, 2005, which is incorporated herein by reference.

### FIELD OF THE INVENTION

Products and method for the preparation of a distilled alcohol-containing beverage which is combined with caffeine. The present invention provides a palatable alcoholic beverage in which the bitter flavoring of caffeine is neutralized.

### BACKGROUND OF THE INVENTION

Patrons of bars and nightclubs seek the stimulation of caffeine with the euphoria associated with consuming hard spirits. Typically, these patrons tend to be younger, more active, and apt to continue their activities late into the evening. In the past, these individuals combined vodka (spirits) with energy drinks in order to achieve the stimulation of caffeine combined with the euphoria of distilled beverages; however, many did not like the taste of these combinations.

Caffeine is inherently bitter and contributes to a “briskness of flavor, which in . . . overinfused brews can easily deteriorate into bitterness.” (National Geographic, January 2005, “Caffeine” by T. R. Reid, pg. 26). In the United States, the consumption of caffeinated beverages tops an average of 104 gallons per person per year (Buzz, The Science and Lore of Alcohol and Caffeine, Stephen Braun, Oxford University Press, New York, Oxford, 1996), with the top three beverages including colas, coffee and tea.

Other inventions describe sport energy drinks, malt/fermented beverages, carbonated beverages, and water containing caffeine.

U.S. Patent Application 2003/0134007 by Erik Thurman Donhowe describes an alcohol containing sport drink that alleges enhanced nutrition in comparison to existing alcoholic drinks.

U.S. Patent Application 2005/0019427 by Bjorn T. Langeland refers to a composition preferably manufactured as a beverage capable of promoting alcohol and acetaldehyde metabolism to mitigate the burden on human body, thus effective for preventing overdrunkenness, drunken sickness, and hangover.

U.S. Patent Application 2004/0180112 by Yoshihide Hagiwara refers to a process for the production of alcoholic drinks having a rich aroma of coffee by utilizing an extraction residue of roasted coffee beans which is yielded in large amounts in the making of instant coffee, coffee drinks and the like.

U.S. Pat. No. 4,497,842 by Joseph R. Ehrlich et. al. refers to a method of preparing roasted citrus fruit peel which comprises extracting the roasted peel with aqueous ethanol, removing the aqueous ethanol from the peel and roasting the thus treated peel. The aqueous ethanol may be recovered for use as an alcoholic beverage. The treated peel is useful in preparing a substitute for coffee or tea by extracting the treated peel with water.

### SUMMARY OF THE INVENTION

This invention relates to the combination of a clear or translucent alcoholic beverage, such as vodka, gin, rum, tequila, or whisky, with caffeine and optional flavorant additives, such as sweeteners, masking agents, natural and/or artificial flavoring agents, and/or other additives to eliminate or mitigate the bitter flavoring associated with caffeine. With a caffeinated vodka, gin, rum, tequila, or whisky, individuals will be able to achieve the stimulation of caffeine combined with the euphoria of a spirit in one beverage and be able to drink the beverage by itself or combined with a favorite mixer of choice.

The present invention relates to a clear or translucent, non-carbonated, distilled alcoholic beverage comprising caffeine and at least one flavorant additive, wherein the beverage has a flavor which is substantially similar to the same clear or translucent, non-carbonated, distilled alcoholic beverage but which does not comprise caffeine and the at least one flavorant additive.

Another aspect of the present invention describes a method comprising combining a clear or translucent, non-carbonated, distilled alcoholic beverage with caffeine, in certain embodiments substantially pure caffeine, and at least one flavorant additive, for example a sweetener, wherein the beverage has a flavor which is substantially similar to, and preferably essentially identical to, the same clear or translucent, non-carbonated, distilled alcoholic beverage but which does not comprise caffeine and the at least one flavorant additive.

The present invention also relates to a clear or translucent, non-carbonated, distilled alcoholic beverage comprising caffeine, wherein the beverage comprises at least 10 mg caffeine per 44.5 mL of the distilled alcoholic beverage, and wherein the beverage is not coffee flavored.

### DETAILED DESCRIPTION

The present invention relates to the combination of caffeine, preferably substantially pure caffeine, and, in certain embodiments, at least one flavorant additive, which may include, for example at least one masking agent and/or at least one sweetener, with an alcoholic beverage, preferably a clear, non-carbonated, distilled alcoholic beverage. In certain embodiments, the invention relates to a clear or translucent, non-carbonated, distilled alcoholic beverage comprising caffeine, wherein the beverage is not coffee flavored. As used herein, “distilled alcoholic beverage” is defined as any beverage containing at least 20% alcohol (or ethanol) by volume (ABV), which has been at some point in its manufacture subject to and/or produced using a distillation process. “Substantially pure caffeine” is defined herein as the compound caffeine as it exists in its pure chemical form, which is not combined with and/or provided in the form of an extract of a naturally caffeine-containing substance, e.g. coffee, also containing flavor components of the naturally caffeine-containing substance. Typically caffeine cannot be found in a distilled alcohol or spirit, and the addition thereof allows the user to receive the stimulation associated with caffeine. In one embodiment, the resulting beverage has a flavor which is substantially similar to, and preferably essentially identical to, the same clear, non-carbonated, distilled alcoholic beverage but which does not comprise caffeine and the at least one flavorant additive.

In one embodiment, the alcoholic beverage is colorless. In certain embodiments, the alcoholic beverage is a vodka, gin, rum, tequila, or whisky. In another embodiment of the beverage of the invention comprises 30%-80% alcohol by volume.

One embodiment of the present invention combines substantially pure caffeine, sweeteners, additives, and distilled vodka (or 80 proof ethyl alcohol) to provide a beverage wherein the bitter flavoring associated with caffeine is masked. The resulting beverage maintains the color and flavor of vodka, but contains caffeine amounting to at least one half the average cup of coffee per 1.5 oz (44.5 ml) serving. In some embodiments, the beverage comprises at least 10 mg caffeine per 44.5 mL distilled alcoholic beverage, in other embodiments at least 20 mg caffeine per 44.5, in other embodiments at least 30 mg caffeine per 44.5 mL distilled alcoholic beverage, in other embodiments at least 40 mg caffeine per 44.5 mL, in other embodiments at least 50 mg caffeine per 44.5 mL, in other embodiments at least 60 mg caffeine per 44.5 mL, in other embodiments at least 70 mg caffeine per 44.5 mL, in other embodiments at least 80 mg caffeine per 44.5 mL. In one preferred embodiment, the beverage comprises 10-80 mg caffeine per 44.5 mL distilled alcoholic beverage. Examples of suitable flavorant additives/sweeteners can be vanilla, anise, almond, pear extracts, cucumber extracts, apple flavorings, citrus extracts, glucose, corn syrup, and/or sucrose and/or mixtures and/or extracts thereof. In other embodiments, the beverage further comprises at least one other masking flavoring. Other examples of flavorant additives/sweeteners or other additives that may be suitable and beneficial for use in certain embodiments of the invention include, but are not limited to, ginseng, panax ginseng, taurine, D-ribose, l-carnitine, glucose, guarana, inositol, glucuronolactone, maltodextrine, niacinamide, niacin, calcium-pantothenate, pantothenic acid, vitamin B₆, vitamin B₁₂, vitamin C (ascorbic acid), folic acid, riboflaven, monopotassium phosphate, gum arabic, pyridoxine hydrochloride, sodium citrate, sorbic acid, benzoic acid, sucralose, and cyanocobalamin.

In certain embodiments, the beverage described in this invention may be clear or translucent and may be composed of 30%-65% ethanol by volume, 35%-70% water by volume, 20-150 mg caffeine per 44.5 mL by volume, and one or more of the following: 20-150 mg sucrose per 44.5 mL by volume, 20-150 mg processed cane sugar per 44.5 mL by volume, 0.5-1.5 mL high fructose corn syrup per 44.5 mL by volume, 0.02-1.0 mL pure almond extract per 44.5 mL by volume, 0.02-1.5 mL pure vanilla extract per 44.5 mL by volume, 0.01-1.5 mL 1.5% diluted pear extract per 44.5 mL by volume, 0.01-2.5 mL cucumber extract per 445 mL by volume, 0.01-1.5 mL Firmenich Natural Masking Flavor 567164 (Firmenich, Inc., Plainsboro N.J.)—0.20% concentration per 44.5 mL by volume, and 0.01-1.5 mL pure anise extract per 44.5 mL by volume.

The method described in this invention in one embodiment comprises the combining a clear, non-carbonated, distilled alcoholic beverage with caffeine, preferably substantially pure caffeine, and at least one, flavorant additive, e.g. a sweetener and/or masking agent, wherein the beverage has a flavor which is, substantially similar to, and preferably essentially identical to, the same clear, non-carbonated, distilled alcoholic beverage but which does not comprise caffeine and the at least one flavorant additive. In certain embodiments, the method can involve combining a clear, non-carbonated, distilled alcoholic beverage with caffeine, preferably substantially pure caffeine in the amounts specified herein, wherein the beverage is not coffee flavored. Upon combining the substantially pure caffeine, any sweetener(s), and any other flavor-enhancing additives with a distilled alcoholic beverage, e.g., vodka, gin, rum, tequila, or whisky, the mixture can be heated to 60-90° C. for up to 2 minutes, followed by cooling to 20-35° C. In other embodiments, the heating process may be omitted if using highly soluble natural or artificial sweeteners or other soluble flavorings. Finally, the mixture can be packaged as the final product.

The function and advantage of these and other embodiments of the present invention may be more fully understood from the examples below. The following examples, while illustrative of certain embodiments of the invention, do not exemplify the full scope of the invention.

### EXAMPLE 1

Composition:

44.5 mL 80 proof ethyl alcohol or clear neutral spirit

40 mg powdered caffeine

15 mL pure vanilla extract

40 mg sucrose

Combine all ingredients in one container. Mixture may be heated up to 75° C. for up to 2 minutes Allow to cool for 5 minutes. By increasing factors of volume, immediately bottle and package.

### EXAMPLE 2

44.5 mL 80 Proof ethyl alcohol or clear neutral spirit

40 mg powdered caffeine

15 mL pure vanilla extract

0.03 mL pure almond extract

40 mg sucrose

Combine all ingredients in one container. Mixture may be heated up to 75° C. for up to 2 minutes Allow to cool for 5 minutes. By increasing factors of volume, immediately bottle and package.

### EXAMPLE 3

Composition:

44.5 mL 80 Proof ethyl alcohol or clear neutral spirit

40 mg powdered caffeine

1.5 mL high fructose corn syrup

20 mg sucrose

Combine all ingredients in one container. Mixture may be heated up to 75° C. for up to 2 minutes Allow to cool for 5 minutes. By increasing factors of volume, immediately bottle and package.

### EXAMPLE 4

Composition:

44.5 mL 80 Proof ethyl alcohol or clear neutral spirit

40 mg powdered caffeine

60 mg sucrose

0.02 mL anise extract

10 mg sodium chloride

0.1 mL pure vanilla extract

Combine all ingredients in one container. Mixture may be heated up to 75° C. for up to 2 minutes Allow to cool for 5 minutes. By increasing factors of volume, immediately bottle and package.

### EXAMPLE 5

Composition:

44.5 mL 80 Proof ethyl alcohol or clear neutral spirit

40 mg powdered caffeine

65 mg sucrose

0.05 mL citric acid

0.1 mL pure vanilla extract

1 mL high fructose corn syrup

0.02 mL pure almond extract

Combine all ingredients in one container. Mixture may be heated up to 75° C. for up to 2 minutes Allow to cool for 5 minutes. By increasing factors of volume, immediately bottle and package.

### EXAMPLE 6

Composition:

100 mL 80 Proof ethyl alcohol or clear neutral spirit

100 mg powdered caffeine

1.5 mL of 0.25% sucralose solution

2 mL of 2% Firmenich Natural Masking Flavor 567164 solution

Combine all ingredients into one container. Mixture may be heated up to 75° C. for up to 2 minutes. Allow to cool for 5 minutes. By increasing factors of volume, immediately bottle and package.

### EXAMPLE 7

Composition:

100 mL 80 Proof ethyl alcohol or clear neutral spirit

100 mg powdered caffeine

1 mL of 1% diluted pear solution

2 mL of 2% Firmenich Natural Masking Flavor 567164 solution

Combine all ingredients into one container. Mixture may be heated up to 75° C. for up to 2 minutes. Allow to cool for 5 minutes. By increasing factors of volume, immediately bottle and package.

### EXAMPLE 8

Composition:

100 mL 80 Proof ethyl alcohol or clear neutral spirit

100 mg powdered caffeine

1 mL of 1% diluted pear solution

Combine all ingredients into one container. Mixture may be heated up to 75° C. for up to 2 minutes. Allow to cool for 5 minutes. By increasing factors of volume, immediately bottle and package.

### EXAMPLE 9

Composition:

100 mL 80 Proof ethyl alcohol or clear neutral spirit

100 mg powdered caffeine

2 mL of 2% Firmenich Natural Masking Flavor 567164 solution

Combine all ingredients into one container. Mixture may be heated up to 75° C. for up to 2 minutes. Allow to cool for 5 minutes. By increasing factors of volume, immediately bottle and package.

### EXAMPLE 10

Composition:

100 mL 80 Proof ethyl alcohol or clear neutral spirit

100 mg powdered caffeine

1 mL of 1% diluted pear solution

1 mL of diluted cucumber solution

2 mL of 2% Firmenich Natural Masking Flavor 567164 solution

Combine all ingredients into one container. Mixture may be heated up to 75° C. for up to 2 minutes. Allow to cool for 5 minutes. By increasing factors of volume, immediately bottle and package.

### EXAMPLE 11

Composition:

100 mL 80 Proof ethyl alcohol or clear neutral spirit

100 mg powdered caffeine

1 mL of diluted cucumber solution

2 mL of 2% Firmenich Natural Masking Flavor 567164 solution

Combine all ingredients into one container. Mixture may be heated up to 75° C. for up to 2 minutes. Allow to cool for 5 minutes. By increasing factors of volume, immediately bottle and package.

### EXAMPLE 12

Composition:

100 mL 80 Proof ethyl alcohol or clear neutral spirit

100 mg powdered caffeine

1 mL of 1% diluted pear solution

1 mL of diluted cucumber solution

Combine all ingredients into one container. Mixture may be heated up to 75° C. for up to 2 minutes. Allow to cool for 5 minutes. By increasing factors of volume, immediately bottle and package.

For any of the Examples above, an increase in caffeine content may allow for a directly proportional increase in all other additives. Mixing, heating and cooling remain the same. Any of the above formulations may be infused with fruit or other flavorings to make a flavored vodka-type beverage.

While several embodiments of the invention have been described and illustrated herein, those of ordinary skill in the art will readily envision a variety of other means and structures for performing the functions and/or obtaining the results or advantages described herein, and each of such variations, modifications and improvements is deemed to be within the scope of the present invention. More generally, those skilled in the art would readily appreciate that all parameters, quantities, materials, and compositions described herein are meant to be exemplary and that actual parameters, quantities, materials, and compositions will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, provided that such features, systems, materials and/or methods are not mutually inconsistent, is included within the scope of the present invention.

In the claims (as well as in the specification above), all transitional phrases or phrases of inclusion, such as “comprising,” “including,” “carrying,” “having,” “containing,” “composed of,” “made of,” “formed of,” “involving” and the like shall be interpreted to be open-ended, i.e. to mean “including but not limited to” and, therefore, encompassing the items listed thereafter and equivalents thereof as well as additional items. Only the transitional phrases or phrases of inclusion “consisting of” and “consisting essentially of” are to be interpreted as closed or semi-closed phrases, respectively. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. Only terms clearly indicated to the contrary, such as “only one of” or “exactly one of,” will refer to the inclusion of exactly one element of a number or list of elements.

What is claimed:

1. A clear or translucent, non-carbonated, distilled alcoholic beverage comprising: caffeine; and at least one flavorant additive, wherein the beverage has a flavor which is substantially similar to the same clear or translucent, non-carbonated, distilled alcoholic beverage but which does not comprise the caffeine and the at least one flavorant additive.

2. A beverage as in claim 1, wherein the at least one flavorant additive comprises a sweetener and/or a natural and/or artificial flavoring and/or a masking agent.

3. A beverage as in claim 1, wherein the beverage has a flavor which is essentially identical to the same clear or translucent, non-carbonated, distilled alcoholic beverage but which does not comprise the caffeine and the at least one flavorant additive.

4. A beverage as in claim 1, wherein the beverage is colorless.

5. A beverage as in claim 1, wherein the distilled alcoholic beverage is vodka, gin, rum, tequila, or whisky.

6. A beverage as in claim 1, comprising 30%-80% alcohol by volume.

7. A beverage as in claim 1, comprising 10-80 mg caffeine per 44.5 mL distilled alcoholic beverage.

8. A beverage as in claim 1, wherein the flavorant additive is selected from a group consisting of vanilla, anise, almond, pear, cucumber, apple, masking agents, citrus extracts, glucose, corn syrup, and/or sucrose and/or extracts thereof.

9. A method, comprising:
combining a clear or translucent, non-carbonated, distilled alcoholic beverage with caffeine and at least one flavorant additive to produce a product beverage having a flavor which is substantially similar to the same clear or translucent, non-carbonated, distilled alcoholic beverage but which does not comprise caffeine and the at least one flavorant additive.

10. A method as in claim 9, wherein the at least one flavorant additive comprises a sweetener and/or a natural and/or artificial flavoring and/or a masking agent.

11. A method as in claim 9, wherein the product beverage has a flavor which is essentially identical to the same clear or translucent, non-carbonated, distilled alcoholic beverage but which does not comprise the caffeine and the at least one flavorant additive.

12. A method as in claim 9, wherein the product beverage is colorless.

13. A method as in claim 9, wherein the distilled alcoholic beverage combined with the substantially pure caffeine and at least one flavorant additive is vodka, gin, rum, tequila, or whisky.

14. A method as in claim 9, wherein the product beverage comprises 30%-80% alcohol by volume.

15. A method as in claim 9, wherein the product beverage comprises 10-80 mg caffeine per 44.5 mL distilled alcoholic beverage.

16. A method as in claim 9, wherein the flavorant additive is selected from a group consisting of vanilla, anise, almond, pear, cucumber, apple, masking agents, citrus extracts, glucose, corn syrup, and/or sucrose and/or extracts thereof.

17. A method as in claim 9, wherein in the combining act, the clear or translucent, non-carbonated, distilled alcoholic beverage is combined with substantially pure caffeine.

18. A clear or translucent, non-carbonated, distilled alcoholic beverage produced by practicing the method recited in claim 9.

19. A clear or translucent, non-carbonated, distilled alcoholic beverage comprising: caffeine, wherein the beverage comprises at least 10 mg caffeine per 44.5 mL of the distilled alcoholic beverage, and wherein the beverage is not coffee flavored.

20. A clear or translucent, non-carbonated, distilled alcoholic beverage as recited in claim 19, wherein the beverage comprises between 10 mg and 150 mg of caffeine per 44.5 mL of the distilled alcoholic beverage.
